(19) United States
(12) Patent Application Publication
(10) Pub. No.: US 2011/0096937 A1
(43) Pub. Date: Apr. 28, 2011

(54) MICROPHONE APPARATUS AND SOUND PROCESSING METHOD

(75) Inventors: Ming Zhang, Nanjing (CN); Wan-Chieh Pai, San Jose, CA (US)

(73) Assignee: FORTEMEDIA, INC., Cupertino, CA (US)

(21) Appl. No.: 12/607,138

(22) Filed: Oct. 28, 2009

(51) Int. Cl. G10K 11/16; H04R 11/04

(52) U.S. Cl. 381/71.11; 381/361

(57) ABSTRACT

A microphone apparatus is provided, including a body, a main microphone and a reference microphone. The main microphone and a reference microphone are disposed on the body for receiving a sound from a source and a noise from other than the source, wherein the main microphone and the reference microphone are arranged vertically towards the source.

### BACKGROUND OF THE INVENTION

1. Field of the Invention

The present invention relates to microphone apparatus, and in particular relates to sound processing method.

2. Description of the Related Art

A microphone is an acoustic-to-electric transducer or sensor that converts sound into an electrical signal. Microphones are used in many applications such as telephones, tape recorders, hearing aids, motion picture productions, live and recorded audio engineering, in radio and television broadcasting and in computers for recording voice, VoIP.

A microphone array comprises any number of microphones. One of the applications of a microphone array is a microphone array system for extracting voice input from ambient noise (notably telephones, speech recognition systems, and hearing aids). In this manner, the microphone array techniques are used to suppress non-stationary noise.

However, to improve communication quality and voice recognition performance of microphones, not only is placement of microphones important, but also is sound processing method.

### BRIEF SUMMARY OF INVENTION

A detailed description is given in the following embodiments with reference to the accompanying drawings.

A microphone apparatus is provided. The microphone apparatus includes a body, a main microphone and a reference microphone. The main microphone and a reference microphone are disposed on the body for receiving a sound from a source and a noise from other than the source, wherein the main microphone and the reference microphone are arranged vertically towards the source.

A sound processing method is provided. The sound processing method comprises arranging a main microphone and a reference microphone vertically towards a source, wherein the main microphone and the reference microphone are used to receive a sound from the source and a noise from other than the source.

### BRIEF DESCRIPTION OF DRAWINGS

The present invention can be more fully understood by reading the subsequent detailed description and examples with references made to the accompanying drawings, wherein:

FIG. 1 illustrates the placement of microphones in a microphone apparatus according to an embodiment of the present invention;

FIG. 2 shows the polar pattern formed by the two microphones of FIG. 1;

FIG. 3 is a schematic diagram of a microphone apparatus according to an embodiment of the present invention;

FIG. 4 is a schematic diagram of the beamformer according to an embodiment of the present invention;

FIG. 5 shows a flow chart of the sound processing method according to the present invention;

FIG. 6 shows detailed steps of the step S508 according to the present invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

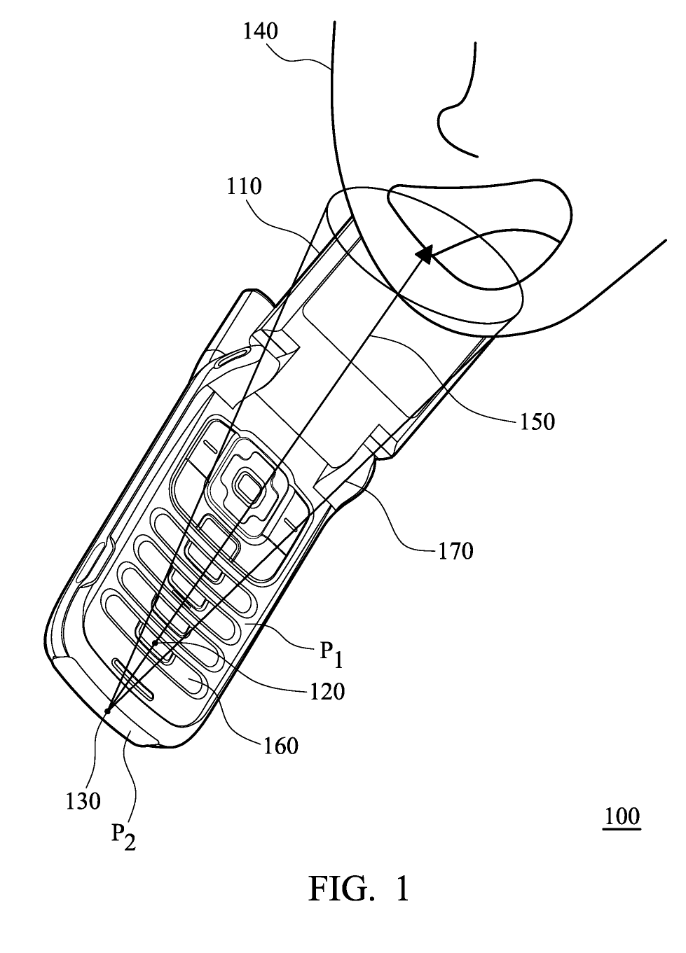

FIG. 1 illustrates the placement of microphones in a microphone apparatus 100 according to an embodiment of the present invention. The microphone apparatus 100 in the present invention at least comprises a body 110, a main microphone 120 and a reference microphone 130.

According to the present invention, the main microphone 120 and the reference microphone 130 are disposed on the body 110 and arranged vertically (in a line 150). For example, the body 110 of the microphone apparatus 100 at least comprises a first plane P1 and a second plane P2, wherein the first plane P1 and the second plane P2 intersects at an angle, for example, 90 degrees. In one embodiment, the main microphone 120 and the reference microphone 130 may be respectively disposed on the first plane P1 and the second plane P2. To be exact, the microphone apparatus 100 may be a cell phone, and a keypad 160 is usually disposed on the first plane P1 of the body 110 as shown in FIG. 1. Therefore, the main microphone 120 may be placed in the middle of the keypad 160 (the first plane P1) while the reference microphone 130 may be placed in the bottom of the cell phone 100 (the second plane P2). Those skilled in the art will appreciate that the invention is not limited in this regard.

The main microphone 120 and the reference microphone 130 disposed on the body 110 are used to receive sounds from an audio source, e.g., a speaker 140 and noises from other than the source, e.g., the environment (not shown). In this regard, the main microphone 120 is closer to the speaker 140 than the reference microphone 130. Thus, the main microphone 120 collects more sounds from the speaker 140 than noises from the environment and the reference microphone 130 collects more noises from the environment than the sounds from the speaker 140. In the present invention, the main microphone 120 and the reference microphone 130 are arranged vertically, towards the speaker 140. Thus, good reception of sounds from the speaker 140 is achieved. In this embodiment, those skilled in the art will understand that the main microphone 120 and the reference microphone 130 is arranged vertically towards the mouth area of the speaker 140 so that a cone-shape beam 170 (as shown in FIG. 1) projected by the two microphones 120 and 130 may cover the mouth area of the speaker 140.

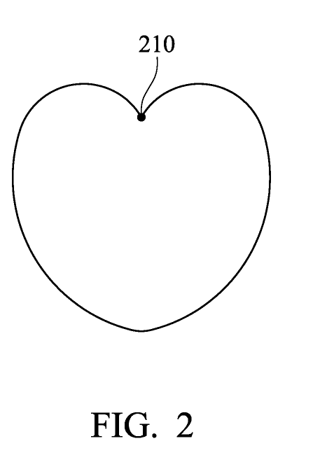

FIG. 2 shows the polar pattern formed by the two microphones 120 and 130. In the present invention, the main microphone 120 and the reference microphone 130 are all omni-directional microphones. As shown in FIG. 2, the beams of the microphones 120 and 130 are in a cardioid pattern with the null 210 towards the audio source 140. Those skilled in the art will know that the sensitivity of the microphones 120 and 130 is kept low in the direction toward the audio source 140 but high in other directions.

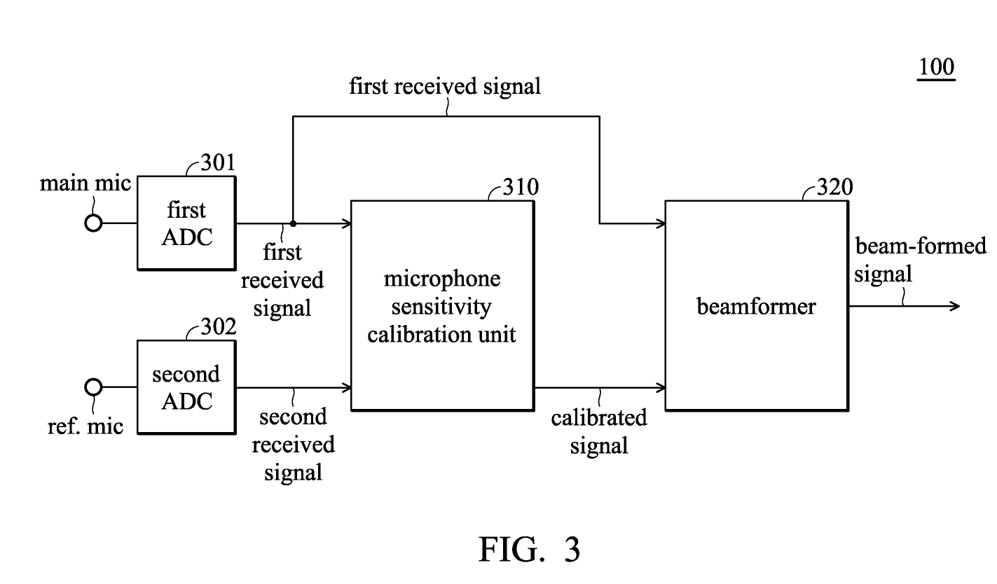

FIG. 3 is a schematic diagram of a microphone apparatus 100 according to an embodiment of the present invention. The microphone apparatus 100 further comprises a first analog-digital converter (ADC) 301, a second ADC 302, a microphone sensitivity calibration unit 310 and a beamformer 320. The main microphone 120 receives the sounds and the noises and provides a first received signal R1 based on the sounds and the noises, and the reference microphone 130 receives the sounds and the noises and provides a second received signal R2 based on the sounds and the noises. The first and second ADC 301 and 302 respectively convert the first received signal R1 and the second received signal R2 from analog signals into digital signals. The microphone sensitivity calibration unit 310 is used to perform sensitivity calibration upon receiving the first received signal R1 and the second received signal R2 and provide a calibrated signal C0 to the beamformer 320. There are various methods to calibrate the sensitivity of the main and reference microphones 120 and 130, and those methods are well-known in the art and not discussed further for brevity. The beamformer is used to output a beam-formed signal B0 based on the first received signal R1 and the calibrated signal C0 beamformer 320. Further details will be discussed in the following paragraphs.

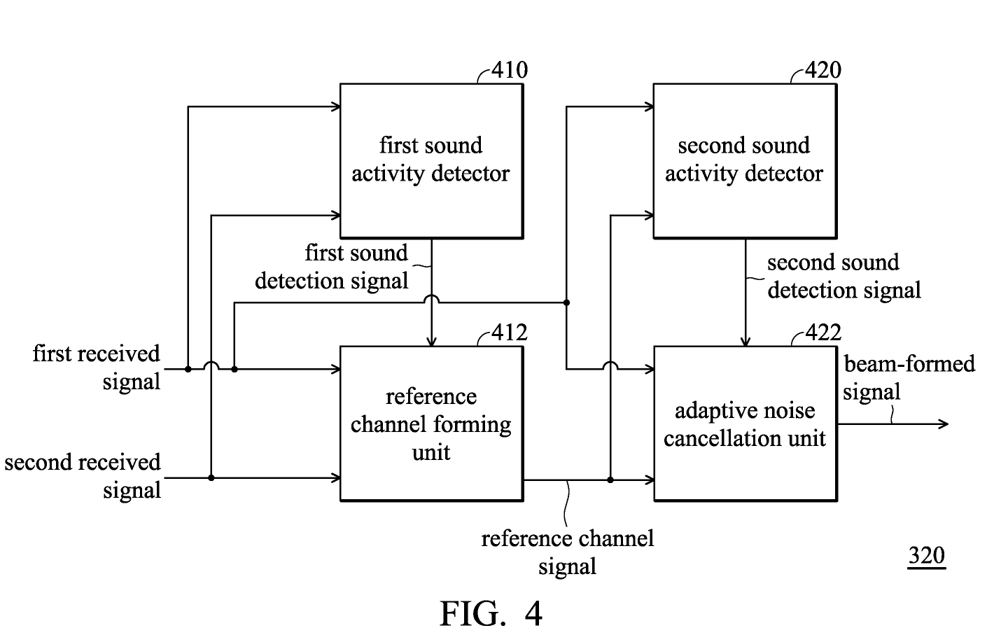

FIG. 4 is a schematic diagram of the beamformer 320 according to an embodiment of the present invention. The beamformer 320 further comprises a first sound activity detector 410, a second sound activity detector 420, a reference channel forming unit 412 and an adaptive noise cancellation unit 422.

The first sound activity detector 410 is used to provide a first sound detection signal V1 based on the first received signal R1 and the calibrated signal C0 to the beamformer 320. The first sound detection signal V1 is used to control the reference channel forming unit 412 as shown in FIG. 4. The reference channel forming unit 412 is used to provide a reference channel signal S0 based on the first received signal R1, the calibrated signal C0 and the first sound detection signal V1 to the reference channel forming unit 412. The reference channel signal S0 contains information about the noises rather than that about the sounds. The second sound activity detector 420 is used to provide a second sound detection signal V2 based on the first received signal R1 and the reference channel signal S0 to the adaptive noise cancellation unit 422. As shown in FIG. 4, the second sound detection signal V2 is used to control the adaptive noise cancellation unit 422. The adaptive noise cancellation unit 422 is used to provide the beam-formed signal B0 based on the first received signal R1, the reference channel signal S0 and the second sound detection signal V2 to the adaptive noise cancellation unit 422. The adaptive noise cancellation unit 422 removes the reference channel signal S0 from the first received signal R1 and outputs the beam-formed signal B0. The beamformer 320 produces the beam-formed signal B0 representing the original sounds colleted from the audio source 140.

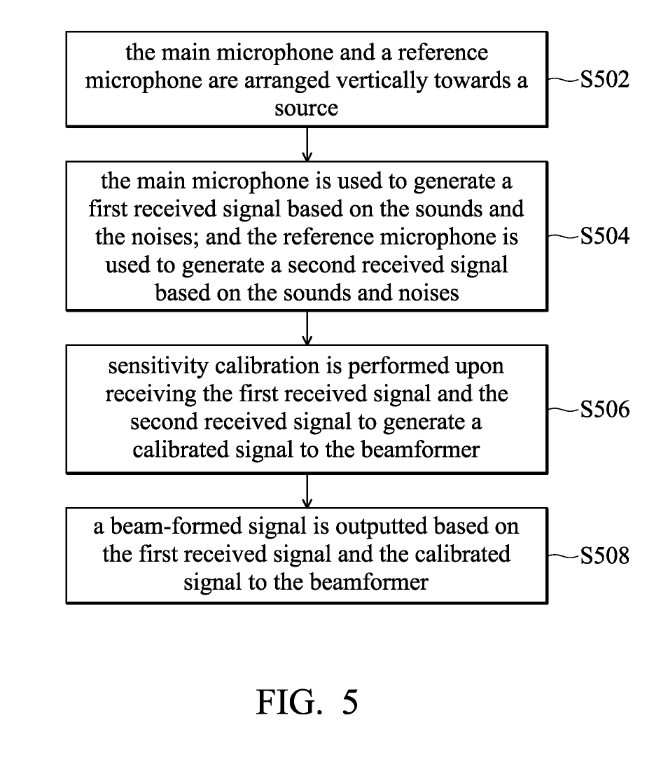

The present invention further provides a sound processing method. FIG. 5 shows a flow chart of the sound processing method according to the present invention. Referring to FIG. 5 and FIG. 1, in step S502, the main microphone 120 and a reference microphone 130 are arranged vertically towards a source, e.g., a speaker 140, wherein the main microphone 120 and the reference microphone 130 are used to receive sounds from the speaker 140 and noises from other than the speaker 140. In step S504, the main microphone 120 is used to generate a first received signal R1 based on the sounds and the noises; and the reference microphone 130 is used to generate a second received signal R2 based on the sounds and noises. In step S506, sensitivity calibration is performed upon receiving the first received signal R1 and the second received signal R2 to generate a calibrated signal C0 to the beamformer 320. In step S508, a beam-formed signal B0 is outputted based on the first received signal R1 and the calibrated signal C0 to the beamformer 320.

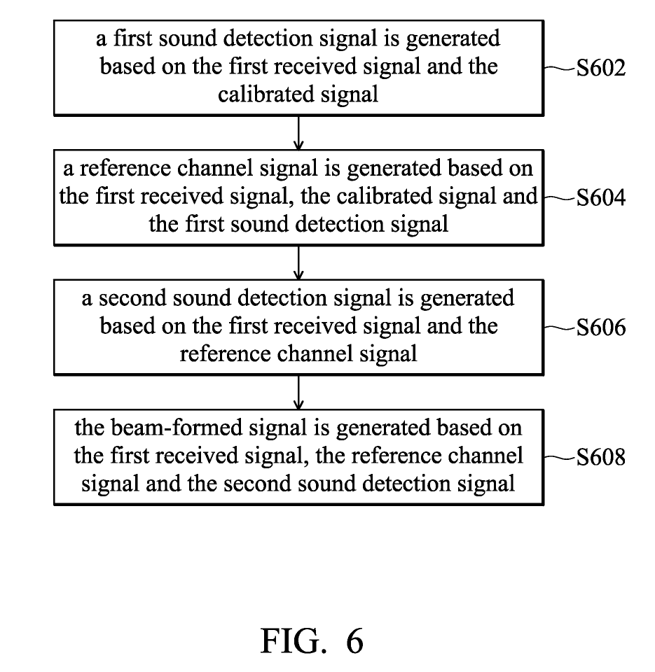

FIG. 6 shows detailed steps of the step S508 according to the present invention. In step S602, a first sound detection signal V1 is generated based on the first received signal R1 and the calibrated signal C0. In step S604, a reference channel signal S0 is generated based on the first received signal R1, the calibrated signal C0 and the first sound detection signal V1. In step S606, a second sound detection signal V2 is generated based on the first received signal R1 and the reference channel signal S0, wherein the reference channel signal S0 contains information about the noises rather than that about the sounds. In step S608, the beam-formed signal B0 is generated based on the first received signal R1, the reference channel signal S0 and the second sound detection signal V2. As discussed above, the reference channel signal S0 (containing information about the noises) will be removed from the first received signal R1 (containing information about all the sounds and the noises) to produce the beam-formed signal B0 representing the original sounds colleted from the audio source 140.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microphone apparatus, comprising:
a body; and
a main microphone and a reference microphone, disposed on the body, for receiving a sound from a source and a noise from other than the source,
wherein the main microphone and the reference microphone are arranged vertically towards the source.

2. The microphone apparatus as claimed in claim 1, wherein the main microphone is closer to the source than the reference microphone is.

3. The microphone apparatus as claimed in claim 1, wherein the main microphone is relatively disposed in the middle of the body and the reference microphone is relatively disposed in the bottom of the body.

4. The microphone apparatus as claimed in claim 1, wherein the main microphone outputs a first received signal based on the sound and the noise, and the reference microphone outputs a second received signal based on the sound and the noise.

5. The microphone apparatus as claimed in claim 4 further comprises a microphone sensitivity calibration unit for performing sensitivity calibration upon receiving the first received signal and the second received signal and outputting a calibrated signal.

6. The microphone apparatus as claimed in claim 5 further comprises a beamformer for outputting a beam-formed signal based on the first received signal and the calibrated signal.

7. The microphone apparatus as claimed in claim 6, wherein the beamformer further comprises a first sound activity detector for providing a first sound detection signal based on the first received signal and the calibrated signal.

8. The microphone apparatus as claimed in claim 7, wherein the beamformer further comprises a reference channel forming unit for providing a reference channel signal based on the first received signal, the calibrated signal and the first sound detection signal.

9. The microphone apparatus as claimed in claim 8, wherein the beamformer further comprises a second sound activity detector for providing a second sound detection signal based on the first received signal and the reference channel signal.

10. The microphone apparatus as claimed in claim 9, wherein the beamformer further comprises an adaptive noise cancellation unit for providing the beam-formed signal based on the first received signal, the reference channel signal and the second sound detection signal.

11. The microphone apparatus as claimed in claim 1, wherein the main microphone and the reference microphone are all omni-directional microphones.

12. The microphone apparatus as claimed in claim 1, wherein the body comprises at least a first plane and a second plane intersecting at an angle, wherein the main microphone is disposed on the first plane, and the reference microphone is disposed on the second plane.

13. A sound processing method, comprising:
arranging a main microphone and a reference microphone vertically towards a source, wherein the main microphone and the reference microphone are used to receive a sound from the source and a noise from other than the source.

14. The sound processing method as claimed in claim 13 further comprises:
using the main microphone to generate a first received signal based on the sound and the noise; and
using the reference microphone to generate a second received signal based on the sound and the noise.

15. The sound processing method as claimed in claim 14 further comprises:
performing sensitivity calibration upon the first received signal and the second received signal to generate a calibrated signal.

16. The sound processing method as claimed in claim 15 further comprises:
outputting a beam-formed signal based on the first received signal and the calibrated signal.

17. The sound processing method as claimed in claim 16 further comprises:
providing a first sound detection signal based on the first received signal and the calibrated signal.

18. The microphone apparatus as claimed in claim 17 further comprises:
providing a reference channel signal based on the first received signal, the calibrated signal and the first sound detection signal.

19. The microphone apparatus as claimed in claim 18 further comprises:
providing a second sound detection signal based on the first received signal and the reference channel signal.

20. The microphone apparatus as claimed in claim 19 further comprises:
providing the beam-formed signal based on the first received signal, the reference channel signal and the second sound detection signal.
